(19) United States
(12) Patent Application Publication
(10) Pub. No.: US 2010/0120405 A1
(43) Pub. Date: May 13, 2010

(54) METHOD AND SYSTEM FOR EFFICIENT CALL INITIATION IN INTERNET-BASED MOBILE TELEPHONY SYSTEMS

(75) Inventors: Yehoshua Sapir, Tel Aviv (IL); Bezalel Finkelstien, Petach Tikva (IL); Shay Horovitz, Rishon Lezion (IL)

Correspondence Address: The Law Office of Michael E. Kondoudis, 888 16th Street, N.W., Suite 800, Washington, DC, 20006, US

(73) Assignee: CELL2NET LTD, Tel Aviv (IL)

(21) Appl. No.: 12/295,128

(22) PCT Filed: Mar. 29, 2007
(86) PCT No.: PCT/IL2007/000417

§ 371 Date: Jan. 25, 2010

Related U.S. Application Data
(60) Provisional application No. 60/787,646, filed on Mar. 31, 2006.

(51) Int. Cl. H04M 3/42

(52) U.S. Cl. 455/417; 370/352

(57) ABSTRACT

Method and system for optimizing the process of initiating a phone call (call placement) on a mobile phone wherein the call routing is monitored and managed through the Internet. A mobile phone user is connected to a dedicated web server with a user-friendly interface that gathers predefined user's identification parameters, in particular: the user's location, the user's phone and subscriber numbers, the destination phone number, and various details that may be applicable to the specific user and the specific mobile network. Then, the most cost-effective (in call rates terms) or most quality-effective (in voice quality terms) option is selected automatically (or semi-automatically). The system then creates the most efficient configuration (call-through, call-back or a mixed configuration thereof) between the user's mobile phone and the destination phone.

### FIELD OF THE INVENTION

The present invention relates generally to mobile telephony systems, and more specifically to Internet-based mobile telephony systems.

### BACKGROUND OF THE INVENTION

Mobile telephony services have developed dramatically in the last decade. Mobile phone users (also referred to as “subscribers”) are provided today with better area coverage and a better voice quality, as well as an Internet connectivity and most of the services offered to wire-line phone users. In addition, users from one mobile phone network can continently roam to another network, be it a different mobile network in the same country or anywhere else around the globe. (For the sake of generality purposes, the term “mobile phone” may be replaced with “mobile device” and includes conventional cellular phones as well as any personal device accessory (PDA) with telephony functionalities).

Usually, a roaming user is able to perform a direct international call, by dialing the relevant country and area code of the destination phone prior to dialing the destination phone number directly from his or her mobile phone. However, the rates that host mobile networks charge roaming users for direct international calls can be extremely high. Therefore, several alternative methods for direct international calling have been developed along the years. The first method is called “callback” or “call-back”. According to this method, a mobile phone user initiates a request for an incoming call for his or her mobile phone. This may be done by other means than a phone call, for example via a short message service (SMS) of via the Internet. The request for the incoming call is received by a dedicated callback server, usually situated, and part of the infrastructure of the host mobile network. Once activated, the server generates an incoming call to the user's mobile phone wherein the destination phone also receives a phone call from the server which also connects the two phones (the user's mobile phone and the destination phone) and a phone call is established between them. Reduction of the call's costs is made possible in case where the call rates from the user's country (where his or her original mobile network is located) are lower than call rates from the host network abroad to the user's original mobile network.

Another alternative for direct international calls is called “call-through” a method that in many cases involve the use of the so-called “calling cards”. According to this method, the user's phone initiates a call to an intermediate private branch exchange (PBX) that routes the call to an interactive voice response (IVR) system (either local or remote) for the purpose of user identification by entering a personal identification number (PIN) that is written on the calling card. After user's identification, the user is requested to enter the destination number and subsequently, the user's request to open a call to the destination phone is processed. The call to the destination phone is then conducted is a much lower rate. Today, the call from the PBX to the network of the destination phone may be conducted via the Internet, in voice over Internet protocol (VOIP) format, which further reduces the call costs significantly.

The use of calling cards is regarded cumbersome and time consuming. Specifically, in order to initiate an international call using call-through, 35 to 40 numbered have to be dialed. This may pose an additional difficulty as some mobile phones only support up to 20 numbers dialed at a time and the use of call-through in these older phoned have to be performed in two stages (in this case the user also has to remember the destination number and dial it during the second stage.

FIG. 1A shows a schematic block diagram of a typical call-through system for initiating international calls from a mobile phone, according to the prior art. The system comprises a user's mobile phone 100, a local PBX 130 that is physically located near the user's mobile phone 100, connected to a remote PBX 120 via a telephony connection (aka transparent communication link) physically located near the destination phone 110 (that may be a mobile phone, a wire-line phone or an Internet-based phone). Whenever the user wants to initiate a phone call, he or she dials a sequence of numbers that direct him to a the local PBX 130 which automatically routes the call to the remote PBX 120 for identifying and verifying the user's parameters as well as to receive the number of the destination phone 110. The remote PBX 120 then connects to the destination phone and establishes a phone call between the user's mobile phone 100 via the local PBX 130, and the destination phone 110.

FIG. 1B shows a schematic block diagram of a typical call-back system for initiating international calls from a mobile phone, according to the prior art. The system comprises a user's mobile phone 100, a PBX 150, and a server 140. Whenever the user wants to initiate a phone call using the call-back mode, he or she sends a request message to the server 140. The server 140, in turn, sends a message to the PBX 150 that, upon identifying the number of the user's mobile phone 100 (typically by using a caller ID) initiates a call-back to the user's mobile phone 100 as well as to the destination phone 110, thus the connection between the user's mobile phone 100 and the destination phone 110 is established.

In addition to call-back and call-through, different mobile networks offer different deals for their subscribers. The call rates according to these deals change from subscriber to another, from country to another and are updated frequently. Therefore it is a difficult task to choose ad hoc the optimal way of call placement (or call initiating) given the various user's and call parameters.

Therefore, several attempts have been made to help the mobile phone user, choose the most cost-effective solution for call initiating in accordance with the ad hoc parameters. Most notably, PCT Patent application No. WO2005117524 which is incorporated by reference in its entirety herein, discloses a method and a system for optimizing the placement of outgoing calls from mobile phones. Specifically, the method helps the user, to choose the optimal route (call-through, call-back etc.) in rate costs terms, according to the user's parameters, in particular, the user's location, the destination phone's location, and the various subscribers' deals. The method is implemented by dedicated software that has to be downloaded to the user's mobile phone, which is a drawback since not all mobile phones currently available enable software downloads.

Therefore, it would be advantageous to have system and method that will automatically selects the most cost-effective way for a mobile phone user to initiate a call, given his or her specific parameters, wherein no software download is required In addition, it would be advantageous if while performing either a call-through or a call-back, the initial connection from the user's mobile phone would be to a local Internet server or a PBX for further reduction of costs.

### SUMMARY OF THE INVENTION

The present invention discloses a system and a method that overcome the drawbacks of the relevant prior art. Specifically, the method and system disclosed provide a quality-effective and/or a cost effective alternative for the currently available mobile-phone-call-initiation processes. According to all embodiments of the invention, a mobile phone user who wants to initiate a call connects to a specific web server over the Internet connection of his or her mobile phone. From this point further, all of the functionalities of the call initiation process are conducted by the user via the Internet connection via a specific web server that monitors and controls the process.

The web server presents the user with a web page inquiring the geographical location of the user or alternatively, detects the location automatically (e.g. by Cell-ID, triangulation and the like). The user then selects the destination phone to be dialed, either from a predefined phone book or by providing the phone number. The phone book may be stored either on the web server or on the mobile phone. Moreover, the destination phone may be a wire-line phone, a destination mobile phone or a voice over Internet protocol based phone (e.g. Skype™). After the destination phone selection, the user is presented with a web page that allows him or her to initiate the call (e.g. by clicking a ‘Dial’ button).

The web server process the information gathered that may include: the geographical location of the user, the subscriber and phone number of the user's mobile phone, the available mobile networks at the user's location, the location of the destination phone etc. The web server then optimizes the appropriate route and call initiation type according to the user's preferences. These preferences may be cost-driven (i.e. reducing the cost of the call), quality-driven (i.e. maintaining a high voice quality of the call), and the like.

The call type may be any of the following type: a call-through from the user mobile phone to the destination phone, a call-back to the user's mobile phone connecting it to the destination phone, a call-through from the user mobile phone whereas the destination phone confirms the call and connects via call-through to the user's mobile phone, a call-through from the user mobile phone whereas the destination phone confirms the call and connects via call-back to the user's mobile phone, a call-back initiated by the user mobile phone whereas the destination phone confirms the call and connects via call-through to the user's mobile phone, and finally, a call-back initiated by the user mobile phone whereas the destination phone confirms the call and connects via call-back to the user's mobile phone.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1A is a schematic diagram showing a typical structure of a call-through system according to the prior art;

FIG. 1B is a schematic diagram showing a typical structure of a call-back system according to the prior art;

FIG. 2 is a schematic diagram showing a call-through configuration according to the present invention;

FIG. 3 is a schematic diagram showing a call-back configuration according to the present invention;

FIG. 4 is a schematic diagram showing a combined call-through/call-back configuration according to the present invention; and

FIG. 5 is a flowchart summarizing the various aspects of the method according to the present invention.

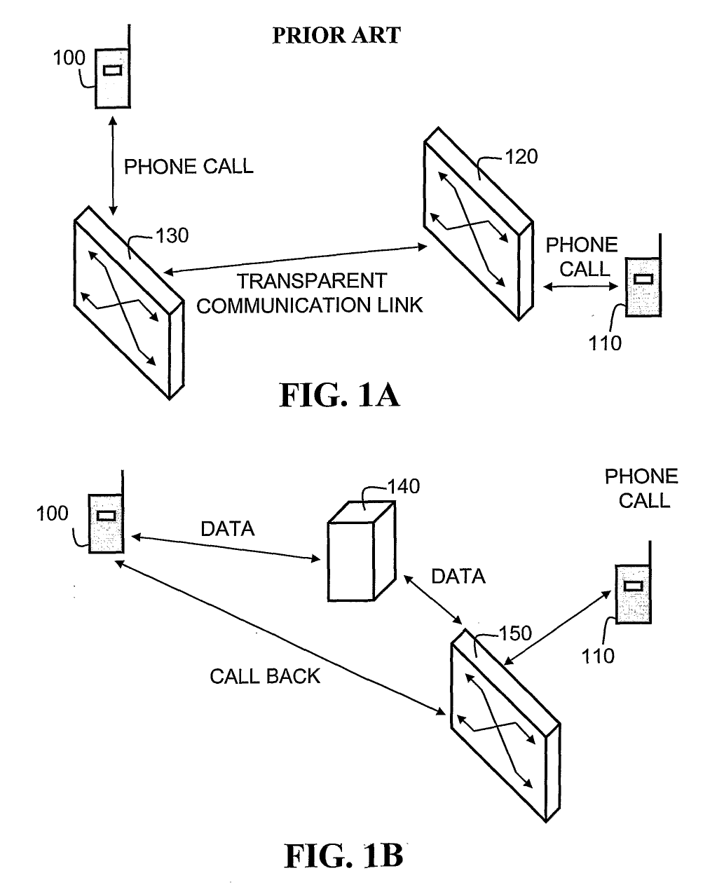

The drawings together with the description make apparent to those skilled in the art how the invention may be embodied in practice.

### DETAILED DESCRIPTION OF THE INVENTION

### Optimizing the Call Initiation Process for Mobile Phone Users

The method and system disclosed provide a quality-effective and/or a cost effective alternative for the currently available mobile-phone-call-initiation processes. According to all embodiments of the invention, a mobile phone user who wants to initiate a call connects to a specific web server over the Internet connection of his or her mobile phone. This may be done via a wireless application protocol (WAP) service or the like. From this point further, all of the functionalities of the call initiation process are conducted by the user via the Internet connection via a specific web server that monitors and controls the process.

The web server presents the user with a web page inquiring the geographical location of the user or alternatively, detects the location automatically (e.g. by Cell-ID, triangulation and the like). The user then selects the destination phone to be dialed, either from a predefined phone book or by providing the phone number. The phone book may be stored either on the web server or on the mobile phone. Moreover, the destination phone may be a wire-line phone, a destination mobile phone or a voice over Internet protocol based phone (e.g. Skype™). After the destination phone selection, the user is presented with a web page that allows him or her to initiate the call (e.g. by clicking a ‘Dial’ button).

The web server processes the information gathered that may include: the geographical location of the user, the subscriber and phone number of the user's mobile phone, the available mobile networks at the user's location, the location of the destination phone etc. The web server then optimizes and determines the appropriate route configuration and call initiation type according to the user's preferences. These preferences may be cost-driven (i.e. reducing the cost of the call), quality-driven (i.e. maintaining a high voice quality of the call), and the like.

The call type may be any of the following type: a call-through from the user mobile phone to the destination phone, a call-back to the user's mobile phone connecting it to the destination phone, a call-through from the user mobile phone whereas the destination phone confirms the call and connects via call-through to the user's mobile phone, a call-through from the user mobile phone whereas the destination phone confirms the call and connects via call-back to the user's mobile phone, a call-back initiated by the user mobile phone whereas the destination phone confirms the call and connects via call-through to the user's mobile phone, and finally, a call-back initiated by the user mobile phone whereas the destination phone confirms the call and connects via call-back to the user's mobile phone.

### Call-Through Configuration

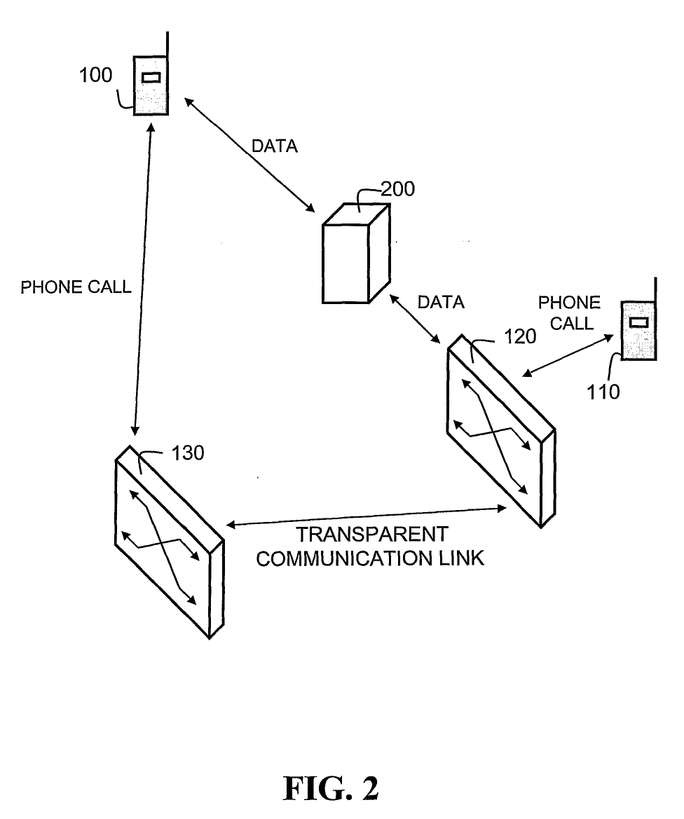

FIG. 2 shows a schematic diagram of the structure required for initiating a call-through call according to the present invention. The system comprises a user's mobile phone 100 coupled via a telephony connection to a local private branch exchange (PBX) 130 which is, in turn, coupled via telephony connection (aka transparent communication link) to at least one remote PBX 120, which is, in turn, coupled via a telephony connection to at least one destination phone 110. The remote PBX 120 is coupled via the Internet to a dedicated web server 200 which is coupled in turn, via the Internet to the user's mobile phone 100.

Upon operation, an Internet connection is established between the user's mobile phone 100 and the dedicated web server 200. The dedicated web server 200 sends the user's mobile phone 100, a web page inquiring on the user's geographical location. According to some embodiments, the geographical location of the user is automatically extracted from the Cell Id, through the Internet link, by triangulation methods and the like.

According to some embodiments, at that point (or at any point later on) the user is enabled to choose and/or change the systems setting and the dialing and other services. For example, the user may choose his if he or she prefers reduced costs, high voice quality and the like. The user may also choose other services besides establishing a regular call, like recording the call that is about to take place, sending the recording of the call as a file via the internet to an email address and the like.

After the user's settings, location and other user's identification information have been gathered by the dedicated web server 200, the dedicated web server 200 presents the user's mobile phone 100 with another web page. This web page requests the user to enter the number of the destination phone 110. Alternatively, the user is presented with a phone book (aka ‘buddy list’) that is stored either on the user's mobile phone 100, or on the dedicated web server 200. All the above mentioned information, specifically, the user's mobile phone 100 numbers. The subscriber number, the destination phone number the user's location, the user's settings and chosen dialing services are combined to a data structure called message request.

Subsequently after this, the dedicated web server 200 presents the user with another web page enabling the user to activate the call (for example by clicking a ‘Dial’ button). By activating the call, the user's mobile phone sends the dedicated web server 200 an activation message.

In case call-through routing configuration has been picked up, the dedicated web server 200 finds the most efficient route of PBXs (specifically the nearest PBX) in quality or cost terms, in accordance with user's settings (preferences) and the user's mobile phone dials the preferred (nearest, or most suitable) local PBX 130. Then, the local PBX 130 is connecting to the remote PBX 120. The remote PBX 120 in turn delivers the number of the user's mobile phone 100 to the dedicated web server via the Internet. The dedicated web server 200 compares the message request with the number of the user's mobile phone 100. Upon verification it sends a message to the remote PBX 120 to connect to the destination phone 110 and establishes a phone call between the destination phone 110 and the user's mobile phone 100.

According to some embodiments of the invention, the PBXs, 120 and 130 may be implemented either by hardware or software or any combination thereof.

According to other embodiments of the invention, conference calls may be initiated by selecting more than one destination phone numbers. The process, either of call-back or call-through is executed for each destination phone 110 number separately.

### Call-Back Configuration

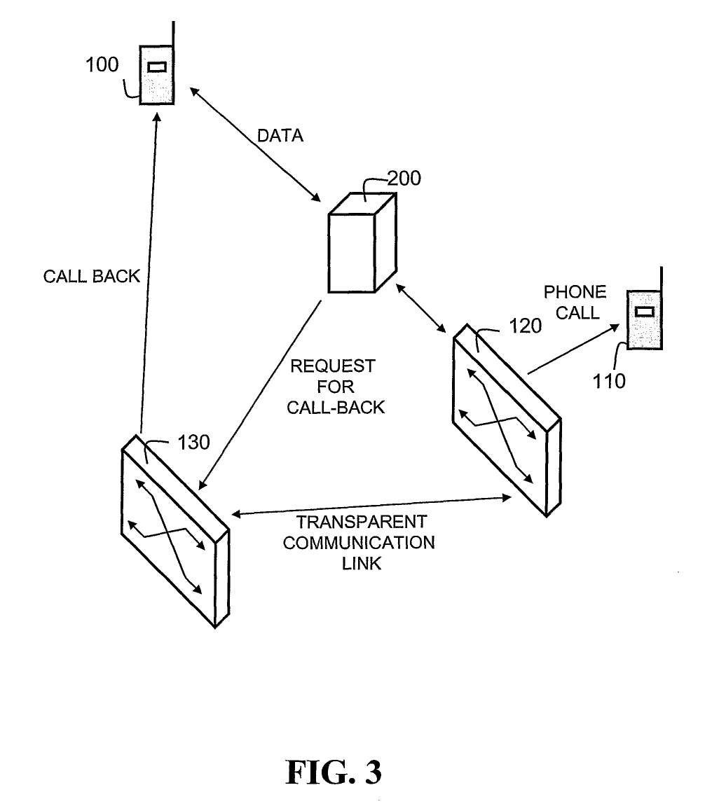

FIG. 3 shows a schematic diagram of the structure of a call-back system according to the present invention. In a similar manner to call-through, the system comprises a user's mobile phone 100 coupled via telephony connection to a local PBX 130 which is, in turn, coupled via telephony connection to a remote PBX 120, which is, in turn, coupled via a telephony connection to a destination phone 110. The local PBX 130 and the remote PBX 120 are coupled via the Internet to a dedicated web server 200. In addition, the dedicated web server 200 is also coupled to the user's mobile phone 100.

The operation of the call-back configuration resembles the first stages of the operation according to the call-through configuration until the activation stage. The operations described below are taken place after the dedicated server holds the message request with all the required information.

First, the dedicated web server 200 sends a request for call-back via the Internet to the local PBX 130, providing the phone number of the user's mobile phone (caller ID). Simultaneously, the local PBX 130 connects to the remote PBX 120 which in turn connects to the dedicated web server 200. As in call-through configuration, the remote PBX 120 delivers the numbers of the destination phone 110 and the user's mobile phone 100 to the dedicated web server 200 via the Internet. The dedicated web server 200 compares the message request with the details of the destination phone 110 and the user's mobile phone 100. Upon verification it sends a message to the remote PBX 120 to connect to the destination phone 110 and establishes a phone call between the destination phone 110 and the user's mobile phone 100.

### Mixed-Messages Configuration

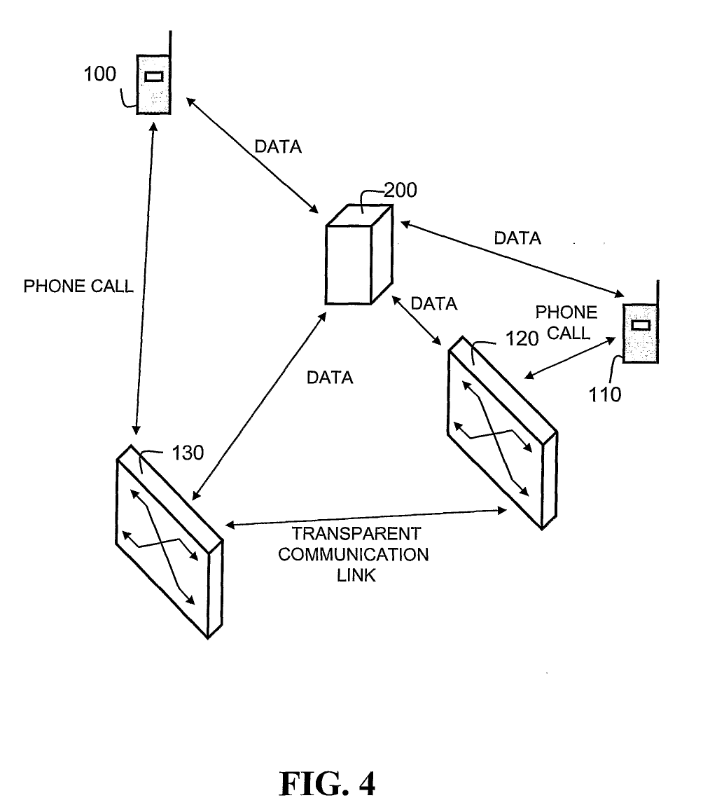

FIG. 4 shows a block diagram of the system having both modes (mixed-messages), call-through and call back. The only difference here from FIG. 3 is that here, the destination phone 110 is also coupled to the dedicated web server 200. The operations described below take place upon user's activation as explained in the call-through and the call-back paragraphs.

The user's mobile phone sends an activation message to the dedicated server 200. The dedicated server 200 send a message to the destination phone 110 asking to confirm a call initiation from the user's mobile phone. The message may be of any type, for example a short message service (SMS) or Internet message (IM). Upon confirmation, the dedicated web server select any of the following modes for establishing the phone call:
(a) A call-through for the user's mobile phone 100 and a call-through for the destination phone 110;
(b) A call-through for the user's mobile phone 100 and a call-back for the destination phone 110;
(c) A call-back for the user's mobile phone 100 and a call-through for the destination phone 110; and
(d) A call-back for the user's mobile phone 100 and a call-back for the destination phone 110;

By this, both sides, the user's mobile phone 100 and the destination phone 110, pay the costs of the local call to the local PBX 130 and the remote PBX 120 respectively. The mixed messages configuration also optimizes better both costs and quality issues as sometimes a call back for one side is optimal whereas the optimal routing for other side is via a call-through.

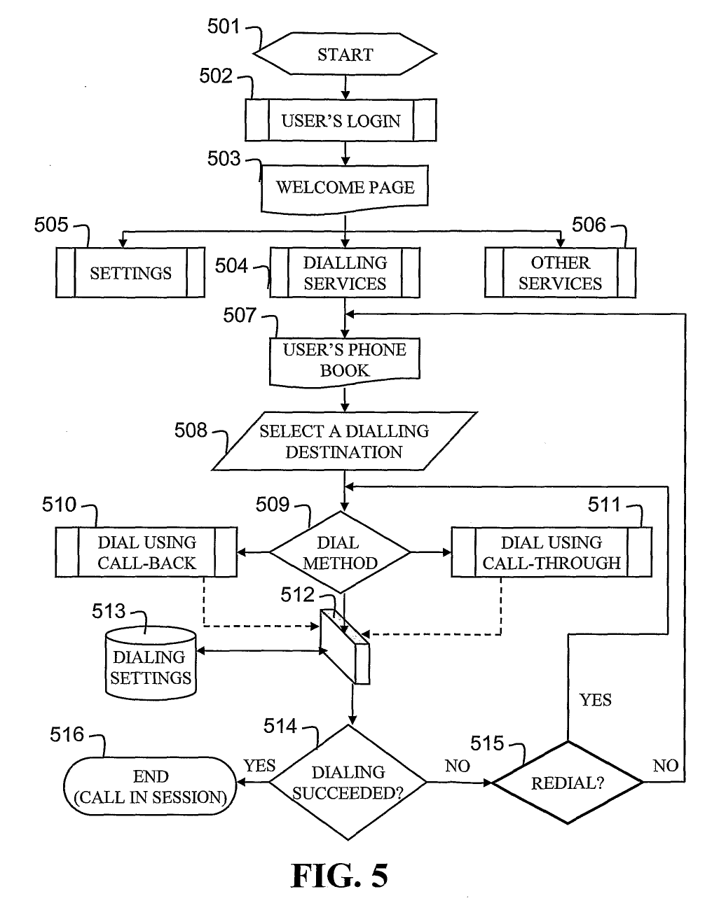

FIG. 5 shows a flowchart summarizing the various aspects of the method according to the present invention. The user starts 501 the call placement process by logging in 502 and connecting to the website of the system according to the present invention. The user is prompted with a webpage 503 asking for his or her location. Alternatively, the location may be gathered by using one of the existing tracking technologies in mobile telephony as explained above. The user may check and update the settings 505, dialing services 504 and other services 506 as explained above that he or she may be affiliated with. Then. The user is presented with his or her phone book 507, containing all the information needed to initiate a phone call, in a user transparent manner. The user then chooses a dialing destination. The most efficient mode is selected by the system 509. The call is being initiated then, either by the call-back process 510 or the call-through process as explained above, wherein the use of local servers and/or PBX 512 contributes to the increase efficiency of the process, as well as to reducing its cost. Dialing setting 513 may be kept on a database connected to the PBX 512 for future use. Whenever a dialing process succeeds 514, the call placement process ends 516 and the call itself begins. Whenever the process is not successful, options of redial 515 or aborting the call placement altogether are provided.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for efficient call initiation in Internet-based mobile telephony systems, said method comprising the steps of
establishing an Internet connection between a user's mobile phone and a dedicated web server;
delivering user's identifying parameters, efficiency preferences and required dialing service to said dedicated web server over the Internet;
delivering user's mobile phone geographical location to said dedicated web server over the Internet;
delivering the destination phone number to said dedicated web server;
activating the call initiation by sending an activation message from the user's mobile phone to the dedicated web server;
determining the most efficient configuration for call initiation;
establishing a phone call between the user's mobile phone and the destination phone using the most efficient configuration in accordance with the user's settings and required dialing service.

2. The method according to claim 1, wherein user's identifying parameters are at least the following: the phone number of the user's mobile phone, the subscriber number of the user, services the user is subscribed to;

3. The method according to claim 2, wherein the efficiency preference include at least one of the following: the costs of the call, the voice quality of the call, the time required to initiate the call.

4. The method according to claim 3, wherein delivering user's mobile phone geographical location is performed by at least one of the following: user chooses the geographical location on a web page, triangulation.

5. The method according to claim 4, wherein required dialing service includes: a regular call, a conference call, recording a call, sending the file containing the recorded call over the Internet to a specific email.

6. The method according to claim 5, wherein activating the call initiation is performed by clicking a ‘Dial’ button on a web page presented on the user's mobile phone.

7. The method according to claim 6, wherein delivering the destination phone number is from a predefined phone book.

8. The method according to claim 7, wherein the most efficient configuration is call-through, wherein call-through initiation process comprising the steps of:
dialing the local PBX;
connecting the local PBX to the remote PBX;
delivering the number of the user's mobile phone from local PBX to the dedicated server via the Internet;
comparing the user's mobile phone number received via the Internet from the user's mobile phone with the number of the user's mobile phone received via the Internet from the remote PBX; and upon verification
sending a message to the remote PBX to connect to the destination phone and establishing a phone call between the destination phone and the user's mobile phone.

9. The method according to claim 7, wherein the most efficient configuration is call-back, wherein call-back initiation process comprising the steps of:
sending a request for call-back via the Internet to the local PBX, providing the phone number of the user's mobile phone;
connecting the local PBX to the remote PBX and the remote PBX to the dedicated web server;
delivering the number of the user's mobile phone from local PBX to the dedicated server via the Internet;
comparing the user's mobile phone number received via the Internet from the user's mobile phone with the number of the user's mobile phone received via the Internet from the remote PBX; and upon verification
sending a message to the remote PBX to connect to the destination phone and establishing a phone call between the destination phone and the user's mobile phone.

10. The method according to claim 7, further comprising a mixed-messages configuration process comprising the steps of:
sending an activation message fro the user's mobile phone to the dedicated server;
sending a message from the dedicated web server to the destination phone asking to confirm a call initiation from the user's mobile phone; and upon confirmation, selecting one of the following mixed-messages configuration for establishing the phone call:
a call-through for the user's mobile phone and a call-through for the destination phone;
a call-through for the user's mobile phone and a call-back for the destination phone;
a call-back for the user's mobile phone and a call-through for the destination phone; and
a call-back for the user's mobile phone and a call-back for the destination phone;

11. A system for efficient call initiation in Internet-based mobile telephony systems, said system comprising:
a user's mobile phone; coupled via telephony connection to
a local private branch exchange (PBX); coupled via telephony connection to
a remote PBX; coupled via telephony connection to
a destination phone;
a dedicated web server; coupled via the Internet to the remote PBX , the local PBX, the user's mobile phone and the destination phone;
wherein upon operation the user's mobile phone delivers information required for establishing the call to the dedicated web server;
wherein the information required for establishing the call comprises the geographical location ,the user's mobile phone number, the subscriber number and the destination phone number;
and wherein the dedicated web server determines the most effective configuration for routing the call according to the information required for establishing the call.

12. The system according to claim 11 wherein the destination phone is one of the following: a mobile phone, a wire-line phone, an Internet-based phone.

13. The system according to claim 11, wherein the PBX is at least one of the following: software based, hardware based, combination thereof.

14. The system according to claim 11, wherein the user's mobile phone connects to the dedicated web server via WAP.

15. The system according to claim 11, wherein the system enables establishing a conference call.
